(19) United States
(12) Patent Application Publication
(10) Pub. No.: US 2026/0176074 A1
(43) Pub. Date: Jun. 25, 2026

(54) Method for Handling Packages with Integrated Damage Control

(71) Applicant: Deutsche Post AG, Bonn (DE)

(72) Inventors: Dennis Kamb, Rösrath (DE); Ulf Nägel, Prüm (DE); Christian-Jochum Franke, Bonn (DE)

(21) Appl. No.: 19/424,355

(22) Filed: Dec. 18, 2025

(30) Foreign Application Priority Data
Dec. 20, 2024 (DE) 10 2024 139 390.4

(51) Int. Cl. B65G 1/137

(52) U.S. Cl. CPC B65G 1/1376; B65G 2201/0235; B65G 2203/042

(57) ABSTRACT

Described and shown is a method for transferring packages each including a packaging material and an article packaged in the packaging material, in particular in a sorting station. In order for it to be possible for the logistical effort as a consequence of damaged articles to be reduced, it is provided that at least one defined control movement for inducing acoustic and/or mechanical response signals depending on possible damage of the article is applied to at least individual ones of the packages to be transferred in a control station, that the response signals are detected by at least one acoustic and/or mechanical sensor, assigned to the control station, and are forwarded to an evaluation unit, that the evaluation unit subjects the response signals to pattern recognition based on a plurality of previously empirically determined correlations of response signals and possible damage of associated articles, that, on the basis of the pattern recognition, the evaluation unit assigns the packages at least one damage parameter which characterizes possible damage, and that the packages are transferred further in a different way depending on the respective damage parameter.

### CROSS-REFERENCE TO RELATED APPLICATION

This application claims priority to German Patent Application No. 10 2024 139 390.4 filed Dec. 20, 2024, the disclosure of which is hereby incorporated by reference in its entirety.

### BACKGROUND OF THE INVENTION

### Field of the Invention

The invention relates to a method for handling packages each comprising a packaging material and an article packaged in the packaging material, in particular in a sorting station.

### Description of Related Art

Methods for handling packages are known from different applications, wherein the packages in many cases are first of all removed from transport units, subsequently sorted or handled in some other way, and finally loaded again in a different composition into transport units. The packages are the entirety of an article, for example a product to be shipped, and a packaging material, in which the article is packaged. Here, like the articles, the packaging materials can have highly different sizes and properties. It can also occur, however, that a large number of identical articles which are packaged in identical packaging materials are handled. Therefore, the articles provided for handling can be of highly different configuration or else can also be of identical configuration to a large extent.

In what are known as sorting stations, the packages are typically first of all removed from transport units and transferred to a conveyor system which can but does not have to comprise conveyor belts. The removed packages are then moved into at least one transport sequence and are transported in this transport sequence to an optical scanner which detects a sorting parameter of the packages. The packages are then fed in the transport sequence by the conveyor system to a sorting installation, in which the packages are sorted based on the sorting parameter. The sorting installation divides the packages of the transport sequence into various sorting sequences. The packages can then be loaded in these sorting sequences into different transport units. Buffer storage of the packages of the different sorting sequences can also take place first of all after the sorting, however. The packages are then loaded later and as required in a different sequence, the loading sequence, into the different transport units.

The packages can be, for example, first of all supplied in bodies of lorries or trailers, can be unloaded and in the process can be separated into a transport sequence. The packages can then be loaded after the sorting into transport units, for example in the form of rolling containers, pallet cages, pallets, pallets with walls or Unit Load Devices (ULD). Unit Load Devices are pallets and containers which are used for loading aircraft and are therefore adapted to the dimensions of aircraft fuselages. What are known as swap bodies, that is to say lorry bodies with supports for parking without a chassis and for a chassis to move underneath for the purpose of loading also come into question as transport units, however, to be precise as transport units to be loaded and also as transport units to be unloaded in the sorting station.

After scanning, the packages can be buffer stored in a buffer store, for instance a rack store or the like, until the packages are transported further. The packages can then be removed from the buffer store in a certain or arbitrary sequence. In order to achieve high efficiency and a low holding time of the packages in the sorting station, buffer storing the packages is often dispensed with, however. The packages are conveyed by a conveyor system from the location of the unloading from transport units to the location of loading into other transport units. The conveyor system can have, for example, conveyor belts, roller conveyors and/or chutes.

In order for it to be possible for the space available in the transport units to be utilized efficiently, size dimensions of the packages are also detected in some cases. A loading algorithm can then stipulate where certain packages should be stacked into the transport units, in order to waste little space.

When packages are handled, in particular, in corresponding sorting stations, it frequently occurs that the articles of the packages have been damaged by preceding events. This is usually only detected, however, during subsequent opening of the packages at the destination. The damaged articles are then in many cases subject to complaints and are returned. A new, undamaged article then has to be delivered as a replacement for the damaged article. Therefore, damaged articles lead to increased logistical effort and, in particular, to unnecessary transport operations.

### SUMMARY OF THE INVENTION

The present invention is therefore based on the object of configuring and developing the method of the type mentioned at the outset and explained in greater detail above in such a way that logistical effort as a consequence of damaged articles can be reduced.

This object is achieved as described herein by a method for handling packages in each case comprising a packaging material and an article packaged in the packaging material, in particular in a sorting station,
in which method at least one defined control movement for inducing acoustic and/or mechanical response signals depending on possible damage of the article is applied to at least individual ones of the packages to be handled in a control station,
in which method the response signals are detected by at least one acoustic and/or mechanical sensor, assigned to the control station, and are forwarded to an evaluation unit,
in which method the evaluation unit subjects the response signals to pattern recognition based on a plurality of previously empirically determined correlations of response signals and possible damage of associated articles,
in which method, based on the pattern recognition, the evaluation unit assigns the packages at least one damage parameter which characterizes possible damage, and
in which method the packages are handled further in a different way depending on the respective damage parameter.

According to the invention, the packages are not simply handled, but rather in the meantime are subjected to damage control. This applies in any case to individual or certain packages. To this end, the packages are handled into a control station, in which a defined control movement is applied to the packages. This can take place during the transport of the packages through the control station. To be exact, however, it will make sense in many cases if the packages remain in the control station during the control operation, with the exception of the control movement. The packages therefore pass into the control station, are not transported further therein, but rather have the control movement applied to them and are only afterward removed again from the control station and are transported further for the purpose of the handling. The control movement can also, however, be applied to the packages while they pass through the control station, without it being necessary for the packages to be halted to this end.

The defined control movement is intended to bring about an acoustic and/or mechanical response signal, based on which possible damage of the article can be extrapolated. For example, the control movement can be a type of shaking or the like. Should the article be formed from glass or porcelain and additionally be broken, rattling or the like would be obtained as a response signal, for example. This rattling might then be recorded and evaluated as or together with other constituent parts of the response signal by way of an acoustic sensor such as, for example, a microphone. As an alternative or in addition, for example, a continued oscillation of the package as a consequence of the control movement might also be detected by way of a mechanical sensor, which continued oscillation would be different depending on whether the article is broken or not. Differences of the continued oscillation can even be determined as required here if an article is not broken, but rather merely torn or cracked. The integrity or damage of the article can fundamentally be extrapolated from the inertia characteristic, with which the package reacts to the control movement. Further response signals which can be used for evaluation are also conceivable.

The at least one response signal which is detected by at least one suitable acoustic and/or mechanical sensor relating to a controlled package can be forwarded for evaluation to an evaluation unit which first of all processes the response signal as required. The processed or non-processed response signal can be compared by the evaluation unit with known response signals. The known response signals can have been previously recorded on packages which have exhibited known damage. In addition, response signals of packages which have not exhibited any damage have possibly been recorded. Here, fundamentally the packages and the damage which have led to the previously known response signals can be highly different, in order for it to be possible for response signals which have been recorded from highly different packages to be evaluated. Here, however, the response signals have preferably been recorded in a manner which is based at least essentially on the same control movements, in order for it to be possible for a greater meaning to be achieved during the evaluation of the response signals.

On account of the previously known response signals, pattern recognition can be carried out based on the response signals detected by means of the at least one sensor, wherein patterns of previously known response signals are compared with patterns of the detected response signal. As a result of the plurality of previously empirically determined correlations of response signals and possible damage of corresponding articles, there are findings which allow certain extrapolations to be made as to damage of the article by identifying certain patterns. General correlations between the response signals and the damage of the packages can be determined, wherein certain patterns of the response signals can be broadly identified, in order for it thus to be possible with high probability for corresponding damage of the articles to be extrapolated based on newly recorded response signals. It is appropriate in this context if the pattern recognition takes place with the aid of artificial intelligence (AI). Here, the AI can be used to determine patterns at all in the preceding empirical analyses. As an alternative or in addition, the AI can also be used to compare the response signals with the previously determined patterns, in order to derive a damage parameter for the corresponding packages therefrom. Corresponding fundamental AI-based methods and processes are known per se and can be readily handled by a person skilled in the art to the present application without requiring special further explanations herefor for a person skilled in the art.

The pattern recognition allows damage parameters which characterize possible damage to be assigned to the packages based on certain response signals of the packages. It does not necessarily come down to highly precise characterization of the damage in every individual case here. In many cases, it is possibly sufficient if the damage parameter is suitable for it to be possible for suitable further manipulating of the associated package to be selected based on the damage parameter. The packages can thus be handled further in a different and respective preferred way depending on the respective damage parameter. For example, damaged articles can be manipulated differently than undamaged articles. It is also conceivable that different damage and/or damage to different articles can each result in different manipulating during the handling of the packages.

Thus, for example, only packages with certain damage parameters can be handled further in a customary way, while the packages with different parameters are removed. The first-mentioned damage parameters are assigned, for example, for packages which are probably not damaged or are only slightly damaged. In contrast, the other damage parameters indicate that the articles of the corresponding packages are considerably damaged or are even destroyed. Further handling and transporting are not worthwhile for packages of this type because the packages cannot be used as intended at the destination. They are then disposed of or sent back at the destination. In order to avoid this, the packages with certain damage parameters are, for example, disposed of directly on-site or prepared for returning directly on-site. Unnecessary further transporting of the packages can then be avoided. The disposal or returning does not, however, have to take place directly in a sorting station. It can therefore be provided that certain transport units are loaded in the sorting station with packages which are assigned an operating parameter which represents a piece part which is only slightly damaged or is even not damaged. In contrast, packages which are assigned a damage parameter representing considerable damage or destruction are loaded into different transport units. The one transport units can then be transported further as provided, while the other transport units are transported further in a way which is different from the provided way, because they are assigned damage parameters which appear to make further transporting as provided inexpedient.

The damage parameter can assume as required only two different values, for instance 0 or 1. Here, one of these values represents a damaged article, while the other value of the damage parameter represents an undamaged article. It is also conceivable, however, for more than two values of the damage parameter to be permitted. A finer graduation can then be made between the two extreme states, namely completely destroyed and completely intact. As an alternative or in addition, how high the probability of damage is can be taken into consideration. For example, the value of the damage parameter can rise with the probability of damage of the article and/or the degree of potential damage of the article. The further procedure with the respective package can then be determined based on the damage parameter. Up to a certain value of the damage parameter, for example, the package can be handled as provided. Only when a certain limit value of the damage parameter is exceeded can the associated package be removed from the provided handling and can as required be returned or disposed of. Here, the limit value can be selected in such a way that, in the case of doubt, packages are handled as provided, and are manipulated in some other way only when damage is expected with very high probability, in particular when this is additionally potentially very serious damage. This is intended to avoid articles which are not damaged or are only extremely slightly damaged from actually being returned or disposed of.

In order to further minimize this risk, it can be provided that packages which are assigned a damage parameter with a value above the above-explained limit value are subjected to a manual review by an employee. The employee can then open the packaging material and examine the article manually and visually for damage. The associated package is returned or disposed of only if the employee actually determines that the article is disproportionally damaged. The employee can decide themselves as required which of the two options is selected.

In the case of a first particularly preferred refinement of the method, an acoustic sensor detects acoustic response signals in the form of the volume of at least certain frequencies and/or frequency bands. The response signals can also be understood to be a response function in the form of an audio frequency spectrum. In many cases, only audio signals of certain frequencies will be relevant for forwarding them for pattern recognition to an evaluation unit. Characteristic noises which allow for possible damage of the article to be extrapolated are then to be expected only in these frequency ranges. Regardless of this, it is appropriate for the sake of simplicity if the at least one acoustic sensor is a microphone.

As an alternative or in addition, at least one mechanical sensor can record a mechanical response signal which represents the oscillation, inertia, deflection and/or force induced by the control movement. For example, the package might be accelerated in at least one direction, to be precise as a consequence of the control movement which is applied to the package, after which the package is braked again. Here, the force for the braking, the deflection during braking in the sense of a braking distance or the inertia which is directed counter to the braking can be determined. As an alternative or in addition, it is also conceivable that an oscillation movement is applied to the package. After the package has been excited to oscillate, the at least one mechanical sensor can be used to determine how the package continues to oscillate. Here, the time period until the oscillation is damped by a certain extent can be relevant. As an alternative or in addition, it can also be relevant how the frequency and the amplitude of the continued oscillation changes while the package continues to oscillate. In other words, it can be expedient, completely independently of the type of signal, for the response signal to be recorded in a time-dependent and/or direction-dependent manner.

In order that the detection of mechanical response signals is not impaired by the control movement itself, it is appropriate if the mechanical response signals are detected following the control movement. The waiting period after the end of the control movement for the detection of the control movements should not be too long, however, in order that the induced response signal can still be measured. Therefore, it will be particularly preferred in many cases if the mechanical response signals are detected at least essentially immediately following the control movement.

In contrast, the detection of acoustic response signals preferably takes place while the control movement is being applied to the package. The acoustic response signals are typically triggered directly by the control movement and do not last for a relatively long time period.

The control movement can be transmitted to the packages via a base plate of the control station. To this end, the packages can be placed onto the base plate. As required, the packages are braced on the base plate or are held laterally by way of holders in order to transmit the control movement. In order to transmit the control movement, the base plate can be moved in at least one spatial direction and/or can be pivoted about at least one spatial direction. A movement in all three spatial directions and pivoting about three pivot axes oriented perpendicularly with respect to one another are conceivable, to be precise in each case at the same time as required.

The control movement can be adapted to the respective package in order to improve the control accuracy in a predefined way. Here, in particular, a frequency and/or an amplitude of the control movement can be adapted. Regardless of this, an adaptation of the control movement can take place based on the response signal which has previously already been determined for the same package. The response signal then allows the type of article to be extrapolated, for which a suitable control movement can then be chosen. As an alternative or in addition, the control movement, in particular the frequency and/or the amplitude of the control movement, can be adapted in a predefined way depending on the type, the size and/or the condition of the package. The type, size and/or condition of the package is then preferably determined before the package passes into the control station.

The packages to be handled can be scanned by way of an optical scanner, in particular in the form of a six-sided scanner and/or a line scanner, in particular an RGB line scanner, and/or a volume scanner. The evaluation unit can then determine the type, size and/or condition of the packages to be handled based on the recordings of the scanner. If this takes place before controlling the packages, the control of the packages, in particular the control movement, can be adapted to the type, size and/or condition of the packages to be handled. As an alternative or in addition, it can also be provided that only packages of a predetermined type, size and/or condition are fed to the control station for assigning a damage parameter. These are then, in particular, packages of this type with an increased probability that the packaged articles are damaged. How packages of this type tend to differ from other packages can likewise be determined in advance empirically by a plurality of investigations.

It is particularly expedient here if the evaluation unit determines the size of the packages in the form of a height, a width and/or a length. These parameters are very objective and comparable. As an alternative or in addition, the evaluation unit can also determine the type of the packages based on the shape, the surface, the type of packaging material, a detected logo, a detected adhesive label, a detected sender address and/or a detected return label. In many cases, this allows relevant extrapolations regarding the package and possibly the article contained therein, which can also be determined empirically in advance as required. At least one of the abovementioned parameters can allow an extrapolation that the package has been produced by a company or a private person, wherein professionally packaged articles are less likely to be damaged. The type, the surface and the shape of the package can be an indication for which protection the packaging material provides and what articles are probably packaged therein. It can then likewise be derived therefrom whether damage of the article is more probable or more improbable, in order to as far as possible check only articles, which can also be damaged with a sufficient probability, in the control station for damage.

It is also conceivable that the evaluation unit determines the condition of the packages based on the moisture of the packaging material, a determined stain of the packaging material, the type and/or arrangement of adhesive tapes attached on the package, a degree of opening of an opening region of the package, the shape of the edges, corners, seams of the package, surface defects of the package such as scrapes, dents, creases, tears and/or slashes. If the packaging material is moist, it can possibly no longer sufficiently protect the article against damage. Here, a stain can indicate that the packaging material was moist and/or an article has leaked. The adhesive tapes can be an indication of how reliably or professionally the article has been packaged. A high degree of opening of an opening region of the package can likewise indicate insufficient packaging of the article. The shape of the edges, corners and seams of the packaging material can likewise, just like a surface defect of the packaging material, such as scrapes, dents, creases, tears and/or slashes, indicate that the packaged article of the package has possibly been damaged by preceding transport.

The control of the packages for damage can achieve a situation where only the packages are fed to a sorting installation and/or a loading station, the damage parameters of which fulfil certain criteria. These criteria can be selected in such a way that the packages with these damage parameters contain articles which are undamaged with high probability. Only packages of this type require sorting and/or renewed loading, wherein the loading can but does not have to take place after sorting. It is fundamentally tolerable here, however, if packages with other damage parameters are occasionally also fed to the sorting installation and/or the loading station. Packages which are assigned other damage parameters, however, are at least treated further or transported further fundamentally differently. These packages are therefore removed from the normal process of the handling, because it is to be assumed with high probability that the articles in these packages are damaged.

In order that the packages with potentially damaged articles do not accumulate but rather can be discharged, it can be provided for the handled packages to be fed to different loading stations for loading the packages into different transport units in a manner at least essentially dependent on the respective damage parameters. Transport units are then loaded with probably undamaged articles, wherein the transport units are then transported further as predetermined. Only packages which probably have damaged articles and are therefore not intended to be transported further as predetermined are loaded into other transport units. These are possibly intended to be returned or disposed of.

The above-described advantages come into effect to a particular extent if, during the handling, the packages are removed from transport units and, in particular after the packages are sorted in a sorting installation, are loaded in a different composition into transport units again. This can be expedient in sorting installations, for example, in order to distribute packages which are supplied in transport units together to different transport units and to transport them further on a different route and/or to different destinations. Here, in particular, rolling containers, pallet cages, pallets, with or without walls, swap bodies, lorries and/or Unit Load Devices (ULD) are appropriate as transport units.

A high throughput during the handling of the packages can be achieved if, after they are removed from the transport units, the packages are fed one after another in a transport sequence to the optical scanner and subsequently to a transfer unit for transferring individual packages from the transport sequence and into the control station. A decision can be made as required depending on the recordings of the scanner as to which packages are transferred from the transfer unit to the control station for damage control. It can thus be achieved that an unnecessary number of packages do not have to be examined in the control station, but rather only those, in the case of which a relatively high potential probability of damage can be extrapolated based on the recordings of the scanner. What parameters can possibly form the basis for this decision has already been discussed above.

Depending on the damage parameters which are assigned to the packages examined in the control station, the packages can be handled from the transfer unit back into the transport sequence again. This can then preferably take place at a different position than the original position in the transport sequence. As an alternative to this, the packages which are assigned other damage parameters can be discharged to a handling installation which is separate from the transport sequence. This serves, for example, to return the packages or to dispose of the packages. Before this takes place, however, it can be provided that the packages are opened by an employee, and that the employee checks whether the corresponding article is actually damaged. If this manual review leads to the result that the article is intact, the article can be packaged again, and the corresponding package can be inserted again into the original transport sequence as if the control in the control station had already resulted in the corresponding article highly probably not being damaged.

For efficient handling of the packages, it is fundamentally expedient if the packages are fed to the sorting installation in the transport sequence which is set downstream of the transfer unit, and are divided into sorting sequences in the sorting installation. The handling of the packages can thus be realized rapidly and with a low space requirement.

The sorting itself can take place highly reliably and rapidly if the evaluation unit detects a sorting parameter of the packages based on the recordings of the optical scanner, and assigns it accordingly to the packages. The packages can then be sorted in the sorting installation in accordance with the sorting parameter. The sorting parameter can be, for example, destination information, for instance an address, which indicates where the relevant package is to be transported.

### BRIEF DESCRIPTION OF THE DRAWINGS

In the following text, the invention will be explained in greater detail based on a drawing which illustrates merely one exemplary embodiment and in which:

FIG. 1 shows a sorting station 1 for handling packages in a diagrammatic view, and

FIG. 2 shows the control station from FIG. 1 in a diagrammatic side view.

### DESCRIPTION OF THE INVENTION

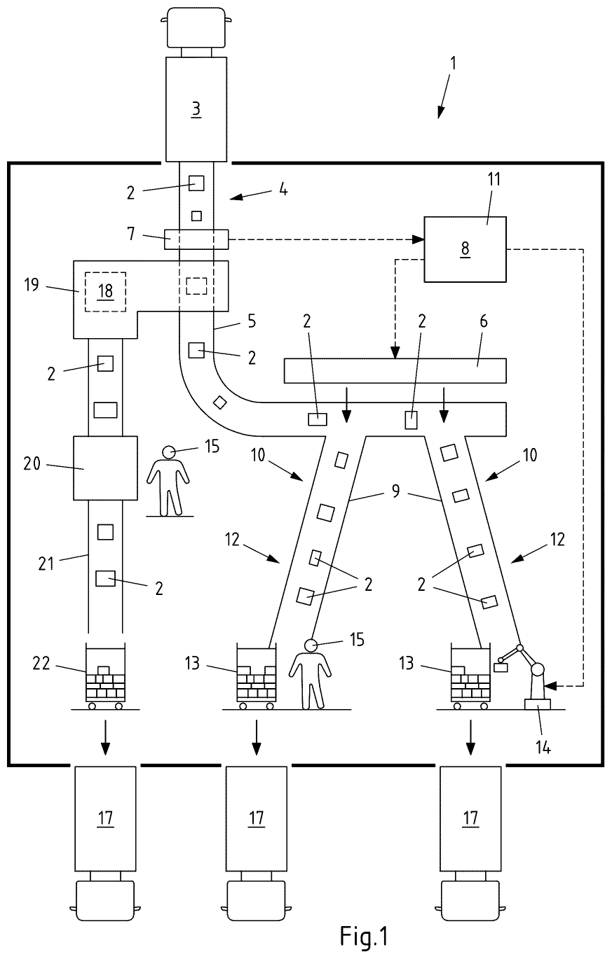

FIG. 1 shows a sorting station 1 for handling packages 2. The packages 2 can be packets, envelopes, bags and/or sacks which comprise piece goods. The packages 2 are moved to the sorting station 1 by way of transport units 3 in the form of commercial vehicles, in particular lorries, trailers and/or semitrailers, wherein the packages 2 are situated in the bodies of the commercial vehicles. On arrival at the sorting station 1, the packages 2 are unloaded and in the process separated. In the method which is shown and to this extent preferred, a single transport sequence 4 of packages 2 is produced from the unloaded packages 2. The transport sequence 4 is transported, in particular at least essentially continuously, by way of at least one conveyor belt 5 through the sorting station 1 as far as a sorting installation 6. If required, a plurality of transport sequences 4 can also be produced which can then be manipulated in parallel in the sorting station 1.

The transport sequence 4 of the packages 2 is fed to an optical scanner 7. In addition, the weight of the packages 2 can be measured. In the method which is shown and to this extent preferred, the packages 2 are transported through a six-sided scanner 7, wherein the packages 2 are each scanned from all six sides. Here, target information such as a postcode is read out, which is relevant for the subsequent sorting of the packages 2 as sorting parameter. The sequence of the packages 2 and the sorting parameters assigned to the packages 2 are transmitted to a control unit 8. The packages 2 are transported from the scanner 7 to the sorting installation 6, where the packages 2 are sorted in accordance with the sorting parameter. The sorted packages 2 are stacked from chutes 9, conveyor belts or other receptacles by a person or a robot 14 into the transport units 13 which are provided for this purpose.

With regard to the packages 2, the described method is appropriate if the packages 2 are piece goods which are packaged by packaging material, in particular in each case piece goods packaged with a box. It is particularly expedient here if the packaging materials are packets, bags, envelopes, pouches and/or packs. Corresponding packages 2 are to be sorted and distributed in sorting stations in large numbers and with a short holding time.

Furthermore, the recordings produced by the scanner 7 are fed to an evaluation unit 11. The evaluation unit 11 determines a plurality of parameters for each package 2 based on the recordings of the scanner 7. One of these parameters can be a sorting parameter, according to which the packages are subsequently sorted in the sorting installation.

In this way, sorting sequences 12 comprising packages 2 are produced which each have identical, similar or associated sorting parameters. Here, in the exemplary embodiment which is shown and to this extent preferred, the sorting parameters of different sorting sequences 12 differ from one another. In addition, in the exemplary embodiment which is shown and to this extent preferred, the packages 2 are placed in the sequence in accordance with the respective sorting sequence 12 into associated transport units 13. The packages 2 from one transport unit 3 can therefore be divided among different other transport units 13.

The placing of the packages 2 into the transport units 13 can take place by way of a robot 14 and/or by way of an employee 15, to be precise as required in the sorting sequence 12. In the case of the sorting station 1 which is shown and to this extent preferred, the loaded transport units 13 are loaded into commercial vehicles 17, in particular lorries or trailers, and are transported away. This is not required. The transport units 13 might also be manipulated in some other way after loading.

The evaluation unit 11 can also, however, determine the size of the packages 2, for instance in the form of a height, a width and/or a length, based on the recordings of the scanner 7. These parameters can be utilized for space-saving stacking of the packages 2 in the transport units 13. It can also be determined based on these parameters, however, which packages 2 should be controlled for damage of the article in a control station 18. In addition or as an alternative, the evaluation unit 11 can use the recordings of the scanner 7 to determine a parameter relating to the shape of the packages 2, the surface of the packages 2, the type of the packaging material, a logo which is provided on the package 2, an adhesive label which is adhesively bonded on the package 2 and/or a return label. At least one of these parameters can be used in addition or as an alternative to specify which package 2 should be controlled for damage of the article in the control station 18. The same also applies to parameters relating to the condition of the packages 2, such as moisture of the packaging material, a stain of the package material, the type and/or arrangement of adhesive tapes on the package 2, a degree of opening of an opening region of the package 2, the shape of at least individual edges, corners and/or seams of the package 2, surface defects of the package 2 such as scrapes, dents, creases, tears and/or slashes. All of these parameters can allow an extrapolation to be made that the article of the corresponding package 2 is damaged with higher probability than, for example, standard packages 2, in the case of which it has been shown empirically that they are extremely resistant to damage.

Depending on the stipulations of the evaluation unit 11 or depending on the conclusions of artificial intelligence (AI) integrated into the evaluation unit 11, a decision can be made based on the corresponding package parameters which have been detected by means of the scanner 7 whether a certain package 2 is removed via a transfer unit 19 from the transport sequence 4 and is transferred to the control station 18. Damage control takes place in the control station 18, in the case of which a control movement is applied to the packages 2.

Depending on the result of the damage control in the control station 18, the packages 2 can be inserted via the transfer station 19 back again into the transport sequence 4 or discharged to an inspection station 20. In the inspection station 20, a check is carried out manually by an employee 15 as to whether the packages 2 are actually damaged or not. To this end, the employee 15 as a rule has to open the packaging materials, in order to obtain sufficient access to the articles. The articles which are then actually recognized as damaged by the employee 15 are then discharged together with the packaging materials in the form of packages 2 to a loading station 21, and are loaded there separately from the packages 2 of the transport sequence 4 and the sorting sequences 12 into separate transport units 22. The packages 2 in these separate transport units 22 can then be sent back to the addressees of the packages 2 or else can be fed to a disposal means. Loading of the corresponding packages 2 into the transport units 22 can be undertaken by an employee or a robot.

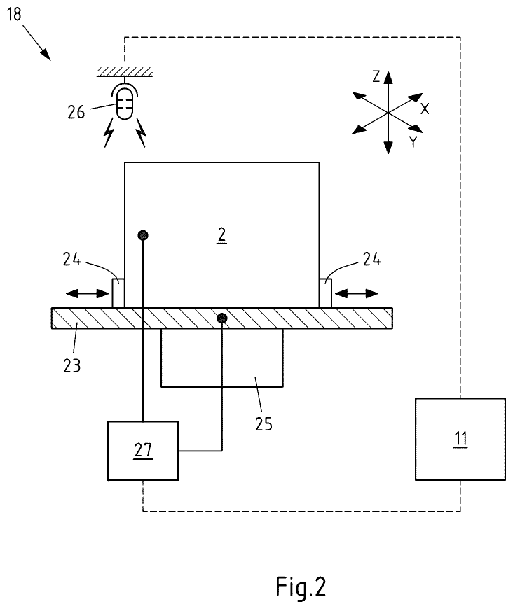

FIG. 2 diagrammatically shows the control station 18 of FIG. 1 in detail. The control station 18 has a base plate 23, to which adjustable holders 24 are attached which can be brought into contact with packages 2 which are of different size and are situated on the base plate 23, in order to hold the corresponding package 2 on the base plate 23. The base plate 23 can be moved translationally by means of a drive unit 25 in the three spatial directions (x, y and z direction). In addition, the base plate 23 can be pivoted by means of the drive unit 25—if required, in a manner which overlaps a corresponding translational movement of the base plate—about the three spatial directions (x, y and z direction). The movement which is transmitted to the packages 2 in this way is called the control movement.

The control movement which is applied in this way to the packages 2 induces, at least potentially, a response signal which can be of acoustic and/or mechanical nature. Here, the acoustic response signal is preferably produced during the transmission of the control movement to the package 2, whereas a mechanical response signal can be produced if required only after the control movement when the response signal cannot be impaired by further movements of the package 2. The acoustic response signal can be detected by way of at least one microphone or a comparable acoustic sensor 26. If required, the sensor 26 can be set in such a way that it detects merely the volume of the response signal of certain sound frequencies or certain sound frequency bands. In many cases, only such information will namely be significant for an estimation as to whether the respective article is damaged or not. If required, this information can also be used for the estimation of the extent to which the article is damaged. This can then be specified as a degree of damage.

The mechanical response signal can be detected by at least one mechanical sensor 27 which records the movement of the movably mounted base plate 23 and/or the movement of the package 2. A movable mounting of the base plate 23 after the control movement is applied allows the base plate 23 and therefore the package 2 to continue to oscillate or the like. It can also be provided, however, that the base plate 23 is fixed after the transmission of the control movement to the package 2, in order to be able to record merely the continued oscillation or the like of the package 2 alone by way of the at least one mechanical sensor 27. In this way, for example, the oscillation, the inertia, the deflection and/or the force which is transmitted from the base plate 23 and/or from the package 2 to the sensor 27 can be detected. This takes place if required in a direction-dependent and/or time-dependent manner, in order for it to be possible for a response signal of relatively high informative value to be recorded.

The control movement which is applied to a certain package 2 can be selected based on the type, the size and/or the condition of the package 2. Here, the type, size and/or condition can be determined based on the recording of the optical scanner 7, as has already been described previously.

As an alternative or in addition, a first control movement is applied to a package 2 and the at least one response signal is recorded. Information about the article packaged in the package or the potential damage can be obtained therefrom, in order thus to select in a targeted manner a second control movement which is subsequently applied to the package 2. It is even conceivable to also select a further control movement based on this second response signal and to likewise transmit this further control movement to the package 2, in order to also obtain a further response signal. The corresponding selection of a control movement takes place by way of the evaluation unit 11, to which the response signals are forwarded.

At least one response signal which is recorded on a package 2 is subjected to pattern recognition in the evaluation unit 11, to which the response signal from the at least one acoustic and/or mechanical sensor 26, 27 is forwarded. Here, the response signal can be compared with a plurality of previously empirically determined response signals, for which the damage or the degree of damage of the article is documented. Similar damage or degrees of damage can then be extrapolated from similar response signals. Here, however, no complete comparison of the response signals is required. It is sufficient if a search is carried out in the newly recorded response signal for patterns which are characteristic for certain damage of articles. In order to locate these patterns, artificial intelligence can be used. Artificial intelligence can likewise be used to determine a damage parameter from the comparison of a new response signal with the previously known patterns which indicate certain damage.

It is conceivable that the damage parameter can assume merely two values. It will be preferred in many cases, however, if the damage parameter can assume more than two values, for instance three, four or five different values. It is also conceivable that the damage parameter can have any desired value from a value range of rational numbers.

### LIST OF REFERENCE NUMERALS

1 Sorting station
2 Package
3 Transport unit
4 Transport sequence
5 Conveyor belt
6 Sorting installation
7 Scanner
8 Control unit
9 Conveyor belt
11 Evaluation unit
12 Sorting sequence
13 Transport unit
14 Robot
15 Person
17 Commercial vehicle
18 Control station
19 Transfer unit
20 Inspection station
21 Loading station
22 Transport unit
23 Base plate
24 Holder
25 Drive unit
26 Sensor
27 Sensor

1) A method for handling packages each comprising a packaging material and an article packaged in the packaging material, in particular in a sorting station,
wherein in a control station at least one defined control movement for inducing acoustic and/or mechanical response signals depending on possible damage of the article is applied to at least individual ones of the packages to be handled, wherein the response signals are detected by at least one acoustic and/or mechanical sensor, assigned to the control station, and are forwarded to an evaluation unit,
wherein the evaluation unit subjects the response signals to pattern recognition based on a plurality of previously empirically determined correlations of response signals and possible damage of associated articles,
wherein, on the basis of the pattern recognition, the evaluation unit assigns the packages at least one damage parameter which characterizes possible damage, and
wherein the packages are handled further in a different way depending on the respective damage parameter.

2) The method according to claim 1,
wherein the acoustic sensor, in particular configured as a microphone, detects acoustic response signals in the form of the volume over at least certain frequencies and/or frequency bands,
wherein, preferably, the acoustic sensor detects the response signals in a time-dependent manner and/or during the application of the control movement to the packages.

3) The method according to claim 1,
wherein the mechanical sensor detects mechanical response signals relating to the vibration, inertia, deflection and/or force induced by the control movement, and
wherein, preferably, the mechanical response signals are preferably detected in a time-dependent and/or direction-dependent manner.

4) The method according to claim 3,
wherein the mechanical response signals are detected following, in particular immediately, the control movement.

5) The method according to claim 1,
wherein the control movement is applied to the packages via a base plate supporting the packages, and
wherein, preferably, the base plate is moved in at least one spatial direction and/or is pivoted about at least one spatial direction.

6) The method according to claim 1,
wherein the control movement, in particular the frequency and/or the amplitude of the control movement, is adapted in a predetermined way to the respective package, in particular in a manner dependent on the response signal which has already previously been determined for the same package, and/or
wherein the control movement, in particular the frequency and/or the amplitude of the control movement, is adapted in a predetermined way in a manner dependent on the type, the size and/or the condition of the package.

7) The method according to claim 1,
wherein the packages to be handled are scanned by way of an optical scanner, in particular in the form of a six-sided scanner and/or a line scanner, in particular an RGB line scanner, and/or a volume scanner,
wherein the evaluation unit determines the type, size and/or condition of the package to be handled on the basis of the recordings of the scanner, and
wherein, preferably, at least essentially only packages to be handled with a predetermined type, size and/or condition are fed to the control station for assigning a damage parameter.

8) The method according to claim 7,
wherein the evaluation unit determines the size of the packages in the form of a height, a width and/or a length, and/or
wherein the evaluation unit determines the type of the packages based on the shape, the surface, the type of packaging material, a detected logo, a detected adhesive label, a detected sender address and/or a detected return label, and/or
wherein the evaluation unit determines the condition of the packages based on the moisture of the packaging material, a determined stain of the packaging material, the type and/or arrangement of adhesive tapes attached on the package, a degree of opening of an opening region of the package, the shape of the edges, corners, seams of the package, surface defects such as scrapes, dents, kinks, tears and/or cuts.

9) The method according to claim 1,
wherein at least essentially only the packages with predefined damage parameters are fed to a sorting installation for sorting the packages and/or a loading station for loading the packages into transport units.

10) The method according to claim 9,
wherein the packages (2) are fed in a manner at least essentially dependent on the respective damage parameters to different loading stations for loading the packages (2) into different transport units (13, 22).

11) The method according to claim 1,
wherein the packages are taken from transport units and, in particular after sorting the packages in a sorting installation, are again loaded with a different composition into transport units, and
wherein rolling containers, pallet cages, pallets, with or without walls, swap bodies, lorries and/or Unit Load Devices (ULD) are used as transport units.

12) The method according to claim 11,
wherein, after they are taken from the transport units, the packages are fed one after another in a transport sequence to the optical scanner and subsequently to a transfer unit for transferring individual packages, in particular in a manner dependent on the recordings of the scanner, from the transport sequence and into the control station.

13) The method according to claim 12,
wherein, in a manner dependent on their damage parameter, the packages are transferred by the transfer unit back into the transport sequence or are output to a treatment installation which is separate from the transport sequence.

14) The method according to claim 12,
wherein the packages are fed to the sorting installation in the transport sequence which results downstream of the transfer unit, and are divided into sorting sequences in the sorting installation.

15) The method according to claim 9,
wherein the evaluation unit detects a sorting parameter of the packages based on the recordings of the optical scanner and assigns it correspondingly to the packages, and
wherein the packages are sorted correspondingly in the sorting installation in accordance with their sorting parameters.
